(19) United States
(12) Patent Application Publication
(10) Pub. No.: US 2018/0309799 A1
(43) Pub. Date: Oct. 25, 2018

(54) Method, Device, and Network for Transferring Data

(71) Applicant: LAIRD BOCHUM GMBH, BOCHUM (DE)

(72) Inventors: GONZALO LUCIONI, WITTEN (DE); GUIDO DORNBUSCH, AHAUS (DE)

(21) Appl. No.: 15/766,964

(22) PCT Filed: Oct. 10, 2016
(86) PCT No.: PCT/EP2016/074130

§ 371 Date: Apr. 9, 2018

(30) Foreign Application Priority Data
Oct. 9, 2015 (DE) 10 2015 219 648.8

(51) Int. Cl. H04L 29/06

(52) U.S. Cl. CPC H04L 65/1016; H04L 65/1036; H04L 65/105; H04L 65/1069; H04L 65/1006; H04L 65/1046

(57) ABSTRACT

A device for transferring data from and to at least one terminal. The device includes at least one apparatus for providing a terminal radio network and at least one apparatus for transferring data to at least one external apparatus. The device includes at least one control and evaluation apparatus. The control and evaluation apparatus is an IMS controller or provides an IMS controller. There is also described a method and a network for transferring data.

The invention relates to a device, method and network for transferring data from and to at least one terminal.

Wi-Fi calling is known from the prior art. Wi-Fi calling allows Wi-Fi-calling-capable terminals to telephone over any Wi-Fi network, using their mobile phone number. In addition, it allows other mobile services, such as sending/receiving SMS/MMS, to be enabled over the Wi-Fi network as well. Supplementary services such as call waiting, conference calling, etc. can also be enabled.

The document Ericsson Review, “Wi-Fi calling—extending the reach of VoLTE to Wi-Fi,” Jan. 30, 2015, discloses an IMS-based system for voice and video communication via LTE. This document further describes the development of voice and video transmission over Wi-Fi. The document describes, for example, data packets being transmitted between a terminal and an EPC (Evolved Packet Core). This data transfer may be encrypted and tunneled. “EPC” refers to the core network, in particular the LTE core network, of a mobile service provider, or the architecture of this core network. The EPC or the architecture thereof enables the operation and coordination of various wireless networks, ensuring mobility, handover, roaming, among others. In this case, the data is not evaluated along the transmission path between the terminal and the EPC.

However, there may be environments in which there are additional apparatuses besides the terminal that are suitable for outputting, inputting or processing the transferred data. In a vehicle, there may be, for example, a hands-free apparatus that serves for outputting audio signals based on the transferred data, and for inputting audio signals. In addition, apparatuses for displaying SMS/MMS, for example an infotainment system display, may exist in the vehicle.

The technical problem that arises is that of creating a device, method and network for transferring data from and to at least one terminal that will enable an improved use of functionalities of multiple terminals in a particular environment.

This technical problem is solved by the subject matter having the features of claims 1, 10 and 16. Further advantageous embodiments of the invention are disclosed in the dependent claims.

A device for transferring data from and to at least one terminal is proposed. The device may of course serve to transfer data from and to a plurality of terminals. Data transfer between the terminal and the device can be wireless data transfer, in particular data transfer via a WLAN (Wireless Local Area Network) or via LTE-U (LTE unlicensed). However, it is also possible for data transfer between the device and a terminal to be wired data transfer, for example via a communication system such as a bus system. The device is thus designed in such a way as to enable at least a wireless data transfer from and/or to a terminal. In addition, wired file transfer can be enabled. The device can also be referred to as a wNode.

The device comprises at least one apparatus for providing a terminal wireless network. The terminal wireless network serves for transferring data between the terminal and the device. The terminal wireless network may in particular be operated in an unlicensed frequency range. The terminal wireless network may preferably be a WLAN wireless network. Alternatively or in addition, the terminal wireless network may be an LTE-U wireless network.

The apparatus for providing a terminal wireless network may provide a wireless access point or the functionalities thereof. For this purpose, the apparatus for providing the WLAN wireless network may comprise at least one antenna element and one transmitting/receiving apparatus.

The device further comprises at least one apparatus for transferring data to at least one external apparatus. The external apparatus is different from the terminal. In particular, the apparatus for transferring data serves to transfer data to an external network. In this case, the external apparatus may, for example, be a server. This apparatus is different from the apparatus for providing a WLAN wireless network.

The data transfer between the device and the external apparatus may preferably be a wireless data transfer. In this case, the apparatus for transferring data may, for example, be designed as a wireless modem. However, it is also possible that the data transfer between the device and the external apparatus may be a wired data transfer. In this case, the apparatus for transferring data may, for example, be a DSL modem. The device is thus designed in such a way as to enable wireless and/or wired data transfer to the external apparatus.

Of course, the device may comprise a plurality of apparatuses for transferring data to at least one external apparatus or to a plurality of external apparatuses. Furthermore, in the case of wireless data transfer to an external apparatus, the device may comprise one or more SIMs, for example one or more SIM card(s). SIM can refer to a “subscriber identity module.” This module may, by means of a credential stored for example in the SIM, enable secure access to a mobile network assigned to the SIM. A SIM may also comprise a plurality of credentials that provide access to a plurality of mobile networks.

If the device comprises a plurality of apparatuses for transferring data to an external apparatus, then each of these apparatuses may be assigned different SIMs or credentials. Alternatively, an apparatus for transferring data can be operated with different SIMs or different credentials.

This enables data transfer over the networks of different mobile service providers.

The apparatus for transferring data to at least one external apparatus may, in this case, have at least one interface for data transfer. In particular, the apparatus for transferring data may be connected, or connection thereof can be made, to at least one external apparatus via the interface having at least one antenna element. As described in more detail hereinbelow, the antenna element may be an antenna element of a vehicle.

Thus, data, particularly in the form of data packets, can be transferred between a terminal and the proposed device via the terminal wireless network. Furthermore, data, likewise particularly in the form of data packets, can be transferred between the device and an external apparatus, in particular an external network, via the at least one apparatus for transferring data.

The device further comprises at least one control and evaluation apparatus. This apparatus may be designed in particular as a microcontroller, or comprise at least one microcontroller. The at least one control and evaluation apparatus is designed as an IMS (IP Multimedia Subsystem) controller.

An IMS refers to a telecommunications system that provides standardized access to the services of different networks. An architecture and the functions of the IMS are specified in particular by the 3GPP committee (3rd Generation Partnership Project committee). A corresponding architecture is described in particular in the documents 3gpp TS 23.402, as of Release 12, Version 12.8.0, available since Mar. 19, 2015, and 3gpp TS 24.302, as of Release 12, Version 12.10.0, available since Sep. 25, 2015. In particular, the IMS allows a data connection between IP-based networks and non-IP-based networks, for example mobile networks following a GSM, UMTS or LTE standard.

Data transfer via IMS, in particular data transfer via the provided terminal wireless network, is carried out according to the SIP (Session Initiation Protocol). This protocol is used to set up, control and terminate a communication session (data transfer session) between two or more participants. The data transfer for transmission of voice data, in particular packet-based data transfer, may be carried out in accordance with RTP/RTCP.

The data transfer may thus be in particular a packet-based data transfer. A terminal may thus also be a SIP user agent. Thus, the terminal can in particular be a SIP-capable terminal.

In particular, the IMS controller can form a SIP proxy or may provide the functionalities of a SIP proxy. Functions of a SIP proxy are described, for example, in the document IR.92, Version 9.0, Apr. 8, 2015, provided by the GSM Association. Also, the IMS controller may serve as a router.

The IMS controller enables the forwarding and/or distribution of the to-be-transferred data to a desired terminal. The controller also makes possible the implementation of the previously described functions for setting up, controlling and terminating a communication session as well as the login, authentication and authorization of a terminal for desired services.

Furthermore, the IMS controller can provide or perform functions of an IMS. Preferably, the IMS controller provides only selected, and thus not all, functions of an IMS. In this sense, “providing” can mean that the IMS controller is able to perform the corresponding function.

The proposed device may in particular be part of a TCU (Telematics Control Unit) of a vehicle or may have a signal and/or data connection to such an apparatus.

In this case, the at least one control and evaluation apparatus may be connected, via a signal and/or data link, to the apparatus for providing the terminal wireless network and to the at least one apparatus for transferring data to at least one external apparatus.

By means of the control and evaluation apparatus, trusted access for a terminal can be provided via the terminal wireless network. The trusted access may be provided in particular in the form of an S2a interface. The control and evaluation apparatus may perform corresponding functions for this purpose. Corresponding functions are described in particular in the documents 3gpp TS 23.402, as of Release 12, Version 12.8.0, available since Mar. 19, 2015.

Furthermore, an access to an EPC of a mobile service provider can be provided via the terminal wireless network. This access can be provided according to guidelines that are described in document IR.61, version 10.0, May 8, 2015, provided by the GSM Association.

In sum, by means of the proposed device, a terminal wireless network can be provided which can serve as a roaming network for a terminal, in particular a portable terminal such as a mobile phone or tablet. The terminal wireless network thus enables data transfer for Wi-Fi calling. Wi-Fi calling may refer to telephony wherein data transfer takes place at least in part via a Wi-Fi network, in particular the described terminal wireless network.

As used herein, the term “telephony” may refer to the setup, control and termination of a connection between two terminals that serves to transfer data for making a voice and/or video call. For the purposes of this invention, telephony also comprises the transmission of data for performing other functions, in particular functions for message transmission, such as a transmission of SMS/MMS, and functions for providing other telephony services, such as call waiting or conference call functions. This data transfer may take place via the provided terminal wireless network.

Advantageously, the proposed device also makes it possible to integrate a plurality of terminals into the data transfer that takes place during Wi-Fi calling. For example, as will be described in more detail below, audio data to be transferred to a mobile terminal, such as a mobile phone, within the framework of Wi-Fi calling, can be transferred to a hands-free apparatus for output. This can be done by means of the above-described IMS controller.

In particular, therefore, data packets are not merely forwarded between the terminal and an external network via the device. Rather, by means of the IMS controller, there is, among other things, an evaluation, optionally a processing, and optionally a targeted control of the transferred signaling data.

The device is a part, and in particular a node, of a network, which can also be referred to as an intermediate network, wherein the data transfer between the terminal and a destination network, which may be for example a home network of a mobile service provider, takes place via the intermediate network. The terminal wireless network may be part of this intermediate network.

The intermediate network may comprise additional nodes, and also in particular stationary nodes. Additional nodes may be designed, for example, as servers. Different functions of the intermediate network may be executed by different nodes.

Thus, for example, data is transferred from the terminal via the terminal wireless network and then transferred from the device to the mobile service provider's home network via an additional node of the intermediate network. The data transfer between the device and another node of the intermediate network may also take place via a network of a mobile service provider. For example, data of the device may be transferred to another node by a wireless modem of the device to a base station of a mobile service provider. In this case, the network of the mobile service provider is used as a medium for transferring data.

Alternatively, the device provides the intermediate network. In this case, the intermediate network does not comprise any additional nodes besides the device. All functions of the intermediate network, in this case, are carried out by the device. In this case, the intermediate network may also be called a femto network. In the case of a femto network, all functions of the intermediate network are performed by the proposed device. Thus, the device may also comprise all elements that are necessary for performing these functions.

The intermediate network forms a roaming network in this case. For this purpose, appropriate agreements must of course be made between a mobile service provider, which provides the destination network, and an operator of the intermediate network. The intermediate network here forms an IMS or provides the functions thereof, but preferably only a part of these functions.

In this case, a roaming network makes it possible for there to be an evaluation, optionally a processing and optionally a targeted control of the data transferred from or to the terminal, in the intermediate network designed as a roaming network, instead of in the mobile service provider's home network, or in addition to the evaluation and/or processing and/or control that takes place in the home network. In particular, telephony functions that can be used by/for the terminal may be performed at least partially or completely in the intermediate network designed as a roaming network, instead of in the mobile service provider's home network. As a result, terminals are also operational outside of the home network.

Further, the device advantageously makes it possible for telephony performed over a mobile network of a mobile service provider to be provided at the desired quality, even in areas where this wireless network has no or poor availability, via the terminal wireless network. If the device is used in a vehicle, then in particular terminals arranged in the vehicle may transfer the relevant data via the provided terminal wireless network, instead of the wireless network of the mobile service provider. Thus, the device may replace a radio cell-based access, for example E-UTRAN access.

In another embodiment, the IMS controller provides a call session control function. This means that the function may be executed or carried out by means of the IMS controller. In this case, in particular, an authentication of the terminal may be performed. Furthermore, the call session control function may be used to control connection setup, connection monitoring and connection termination.

In another embodiment, the at least one terminal is assigned a predetermined identifier. The terminal is, in particular, a terminal that is connectable wirelessly to the device. The identifier may be, in particular, a SIP URI. Furthermore, different apparatuses can be operated under the predetermined identifier by means of the device. In particular, different SIP user agents can be operated under one SIP URI. This can mean that data transferred to the terminal with the predetermined identifier is transferred, alternatively or in addition, to at least one additional terminal. In other words, at least two terminals can be operated under a common identifier by means of the device.

Also, data can be transferred from another terminal under this predetermined identifier. This can occur, for example, within the framework of carrying out the call session control function. In particular, native capabilities of the call session control function of the IMS controller can be used for this purpose. It is also conceivable that parts of the data which are transferred to the terminal with the predetermined identifier, may be transferred exclusively to this terminal by means of the device, while another part of the data may be transferred, alternatively or in addition, to an additional terminal. The additional terminal may also have a signal and/or data connection to the device. Thus, it is possible, for example, to shift the data transfer for audio communication from the terminal with the predetermined identifier to a hands-free apparatus.

As a result, the integration of different terminals into the data transfer is made possible in an advantageous manner.

In another embodiment, the device for transferring data to an external apparatus is a device for wireless data transfer. This has been described above.

In another embodiment, the device comprises at least one position-determining apparatus. The position-determining apparatus may be designed, in particular, as a GNSS sensor. The position-determining apparatus makes it possible to determine the position of the device in a global reference coordinate system.

The nearest base station(s) for establishing a radio connection with the device can then be determined based on this position. Also, a future position can be determined or estimated based on this position, and the nearest base station(s) for establishing a radio connection with the device may be determined based on the future position. The future position may also be determined as a function of driving dynamics variables, e.g. a speed, a steering angle, a yaw rate, etc. The driving dynamics variables can be transferred from the vehicle to the apparatus.

Then, for example, data transfer can take place between the device and the external apparatus via an antenna element of the device or an antenna element connected to the device. As described in greater detail below, the antenna element can be set, and/or selected from a number of different antenna elements, according to predetermined criteria. For example, an antenna element can be selected which allows a data transfer rate to the nearest base station at the highest data transfer rate and/or best data transfer quality.

As a result, data transfer between the device and an apparatus external to the device can be advantageously improved.

In another embodiment, the device comprises or provides a hands-free apparatus. The hands-free apparatus can, in this case, in particular comprise at least one input apparatus for audio signals and/or at least one output apparatus for audio signals. This can mean, for example, that the hands-free apparatus, the apparatus for providing a terminal wireless network, the apparatus for transferring data to at least one external apparatus, and the control and evaluation apparatus, are all arranged in a common housing. The hands-free apparatus can, in this case, serve for the input and/or output of audio signals for telephony by means of a terminal, which is connected to the device e.g. via the terminal wireless network. The hands-free apparatus may be a terminal internal to the device.

This advantageously achieves that the terminal need not be held in the hand for manipulation.

In another embodiment, the device comprises at least one data transfer interface for wired data transfer from and to an external system or external apparatus. The external system may in particular be a communication system. The external communication system can be different, in this case, from the above-described target network. In particular, the external communication system may be a vehicle communication system, for example a corresponding bus system. It is also conceivable that the external communication system may be a bus system within a building communication system.

At least one terminal external to the device may have a data and/or signal connection to the external communication system. In this case, data transfer from and to the external terminal can take place via the data transfer interface. The external terminal can then be operable e.g. by means of the proposed device.

For example, an external hands-free apparatus may be connected to the external communication system. Likewise in this case, the hands-free apparatus may serve for the input and/or output of audio signals for telephony by means of a terminal, which is connected to the device e.g. via the terminal wireless network. The hands-free apparatus may be a terminal external to the device.

By means of the data transfer interface, it is advantageously achieved that terminals external to the device can be integrated into the data transfer or can be used to output and/or input data-transfer data. The data transfer interface for outputting and/or inputting data in a terminal external to the device can in particular serve to provide a user interface for a user. Thus, the described input and/or output of data via terminals external to the device can serve to manipulate the device.

If no apparatus external to the device is connectable to the apparatus via the data transfer interface, or if the desired apparatus is not connectable, a corresponding input and/or output interface may be provided via a web server, the web server being provided by the device, in particular by the control and evaluation apparatus. A corresponding input and/or output apparatus can then be connected to the web server via the terminal wireless network. For example, a tablet PC for outputting messages and/or for entering telephone numbers via the terminal wireless network can be connected to the device via a data and/or signal link.

Of course, the above-described input and/or output interface via a web server can also optionally be provided via the data transfer interface of the device. This makes it possible, for example, to connect a PC via Ethernet.

In another embodiment, the device comprises an apparatus for terminal detection. By means of the apparatus for terminal detection, it can be detected whether a terminal is located in an area of a predetermined size around the proposed device. Alternatively or in addition, the terminal can detect that it is located in the area by means of the apparatus for terminal detection. If a terminal is located in this area, this terminal can change from a transmission/reception mode in which telephony data is via a currently used network such as a wireless network, to a transmission/reception mode in which this data is transferred via either the terminal wireless network provided by the device or the above-described intermediate network (roaming). Thus, if a compatible terminal is detected in the predetermined area, a change condition may be satisfied. Of course, the change may still depend on whether other criteria are met. Terminal detection may, for example, be an NFC-based detection, a Bluetooth-based detection, a Wi-Fi-based detection or an LTE D2D-based detection. For this purpose, it may be necessary for the corresponding terminal to support the corresponding detection method.

The implementation of the detection may depend on the technology used. If the detection is WLAN-based detection, it can for example be carried out according to Wi-Fi Aware procedures. These procedures are specified, for example, by the Wi-Fi Alliance.

As a result, a change (roaming) of the terminal is advantageously made possible or initiated if an availability of the terminal wireless network has been ensured.

The apparatus for terminal detection can also serve to detect additional devices and apparatuses that are different from the described terminals. For example, the apparatus for terminal detection may be used to detect an additional device for transferring data from and to at least one terminal. This device, may for example, be installed in another vehicle or in a building. After successful detection, data transfer can be performed between the devices, for example, in order to carry out desired functions.

In another embodiment, the device is arranged in a vehicle. In this case, the device may be connected to at least one antenna of the vehicle, with the vehicle antenna in particular being connected to the above-described apparatus for transferring data to an external apparatus. The terminal wireless network can thus be provided in a vehicle interior.

Further, data of the device can be transferred between an apparatus of the vehicle, such as a hands-free apparatus of the vehicle, and the device. Furthermore, data can be transferred between the device and other apparatuses of the vehicle, for example a display apparatus or input apparatus. It is therefore conceivable, for example, that transferred text information, such as SMS, can be displayed on a display apparatus of the vehicle. It is also conceivable that the apparatus can be controlled by input via an input apparatus that is external to the device. For example, a telephone number can be input via an external input apparatus and be by the device to set up a call.

Thus, a vehicle is also described having a device according to an embodiment described in the present invention.

Further, a method is proposed for transferring data from and to at least one terminal. The method is performed using a device according to an embodiment described in the present disclosure. Furthermore, the control and evaluation apparatus performs at least one function of an IMS or IMS controller. In particular, the control and evaluation apparatus performs a function of a SIP proxy. This function may in particular be a call session control function.

In a data transfer from the terminal to a destination network, for example a home network, of a mobile service provider, at least one data packet is transmitted from the terminal to the device via the provided terminal wireless network. The control and evaluation apparatus controls the relevant data stream, which is transmitted to the destination network either directly or indirectly, i.e. via other target network apparatuses not assigned to the destination network, by means of the apparatus for transferring data to an external apparatus. Also, a terminal, such as a hands-free apparatus, may transfer data to the device via a wired connection; in that case, this data is transferred by the control and evaluation apparatus to the destination network of this terminal or another terminal connected to the device, as described hereinabove. Data may then be transferred from the destination network to another terminal, e.g. to carry out telephony.

In a data transfer from the destination network to the terminal, the data from the destination network is transferred directly to the device, for example via the apparatus for transferring data to and from an external apparatus. Also, data from the destination network can be indirectly transferred to the device, for example via at least one apparatus associated with a network that is different from the destination network, such as the above-described intermediate network. The relevant data stream is forwarded to one or more terminals by means of the control and evaluation apparatus.

Control of data transfer for telephony can be performed by the control and evaluation apparatus.

In the proposed method, a terminal wireless network can also be provided that allows the implementation of the Wi-Fi calling described at the beginning. In particular, the terminal wireless network can be a roaming network or a part thereof, wherein a terminal for transferring data can change from a connection via a currently used network, in particular a wireless network of a mobile service provider, to a connection via the provided terminal wireless network.

Furthermore, a terminal authentication function can be performed by the control and evaluation apparatus.

Also, a Call Forwarding Unconditional service can be provided by the control and evaluation apparatus. Such a service is described, for example, in the document RFC 5359, published in 2008, which is available for example on the website http://www.rfc-base.org. In the performance of this service, data transfer of audio data to a terminal, e.g. a mobile phone, alternatively or in addition to a hands-free apparatus that is part of the device or has a data and/or signal connection to the device, can take place. This allows transmission of audio signals via the device without any need to hold a terminal in one's hand.

By means of the at least one apparatus for transferring data to and from an external apparatus, data transfer may take place via different home networks of different mobile service providers. For this purpose, a connection may be established between the apparatus for transferring data and a base station of the corresponding mobile service provider. For example, the data transfer may take place via a home network which has the currently highest availability.

For this purpose, several apparatuses for transferring data of the device can be operated with SIMs that are different from one another. Of course it is also possible to operate only one such apparatus with SIMs that are different from one another (multi-SIM operation).

Wi-Fi calling services or telephony functions provided by the device are described, for example, in the documents IR.51, Version 2.0, May 29, 2015 and IR.92, Version 9.0, Apr. 8, 2015 of the GSM Association.

In another embodiment, audio data is transferred to a hands-free apparatus. The audio data may be data of a telephone call with a terminal that is different from than the hands-free apparatus, for example a mobile telephone. The terminal may be connected to the device via the WLAN wireless network. This data transfer can be controlled by the control and evaluation apparatus.

As described above, the hands-free apparatus may be a hands-free apparatus of the device or a hands-free apparatus connected to the device via a signal and/or data link.

This has the advantageous result that it is not necessary to manipulate or hold the terminal that is different from the hands-free apparatus.

In another embodiment, the terminal changes from data transfer via a wireless network that is different from the terminal wireless network, e.g. the network of a mobile service provider, to data transfer via the terminal wireless network. Of course, the terminal can also change from data transfer via the terminal wireless network to data transfer via a wireless network that is different from the terminal wireless network. This may also be referred to as “roaming.” This change may take place through a change between different transmit-receive modes.

Thus, the terminal can change from data transfer via a wireless network that is different from the intermediate network, e.g. via the home network of a mobile service provider, to data transfer via the intermediate network.

This advantageously permits the continuous provision of high data transfer quality.

In particular, after changing to data transfer via the terminal wireless network or the intermediate network, terminal registration and authentication can be carried out by the control and evaluation apparatus. In the case of changing to data transfer over an external wireless network, deregistration of the terminal can be performed.

In another embodiment, data transfer from and to the at least one external apparatus takes place via at least one antenna element, wherein the at least one antenna element is set and/or selected so as to provide a predetermined sensitivity, in particular a maximum sensitivity, in the direction of a selected base station.

The selected base station may be, for example, the currently nearest base station to the device or the future nearest base station.

The device, in particular the apparatus for transferring data, may be connected to an antenna apparatus via a signal and/or data link, the antenna apparatus comprising at least one antenna element. In this case, how the at least one antenna element must be set and/or selected in order to provide the desired sensitivity, can be detected, for example, by a corresponding interaction between the device and the antenna apparatus. The antenna apparatus can then be controlled accordingly.

Also, an antenna element can be selected from a group of at least two antenna elements that has the highest sensitivity in the direction of the selected base station.

The antenna elements may be part of the proposed device. Alternatively, the antenna elements may be part of an apparatus that is different from the device, the device having a signal and/or data connection with this external apparatus. The external apparatus may in particular be an antenna apparatus of a vehicle.

In another embodiment, there is a change in a wireless network for transferring data between the device, particularly the apparatus for transferring data from and to an external apparatus, and an external apparatus such as a base station. The external apparatus to/from which data is transferred may also be changed. For example, a transfer over a first wireless network to a home network of a first mobile service provider may be changed to a transfer via another wireless network to the home network of another mobile service provider. This has already been described above. This change may take place based on an availability of different wireless networks. In particular, this change may take place if the availability of the wireless network currently used for transferring data is less than a desired level.

In another embodiment, a time-parallel data transfer takes place from and to a plurality of terminals, in particular over the terminal wireless network. Time-parallel data transfer may be used in particular for performing telephony with different terminals. As a result, a plurality of users, e.g. vehicle occupants, may engage in telephony simultaneously.

It is also possible that the device may provide the above-described telephony functions simultaneously for a plurality of terminals, in particular a plurality of mobile telephones. In particular, the control and evaluation apparatus may control the data transfer for performing telephony from and to a plurality of terminals having different identifiers, for example different telephone numbers.

Also proposed is a network for transferring data from and to at least one terminal, wherein at least one node of the network is formed by a device according to an embodiment described in the present disclosure. Thus, the device may be part of the intermediate network.

In another embodiment, another node of the network is provided by a device-external server.

The network may also be referred to as an intermediate network. Thus, for example, the data transfer in carrying out the above-mentioned Wi-Fi calling does not take place directly between the terminal and the mobile service provider's home network, for example over an Internet connection. Instead, the data transfer takes place via the intermediate network, with the intermediate network providing an IMS or functions of an IMS. The terminal wireless network provided by the device may be part of the intermediate network. Data transfer over the intermediate network advantageously makes it possible that different apparatuses or their functions may be provided by the terminal for the purpose of performing telephone calls.

In this case, the intermediate network may be an EPC, a corresponding alternative, or in the future possibly an additional successor (5G). However, the intermediate network may only comprise or provide part of the architecture and/or functions of an EPC or a corresponding alternative or future successor network. The intermediate network may be in particular a roaming network. This has already been described above.

The network may be in particular a femto network. In this case, all the functions of the intermediate network are performed by the device. Thus, in this case, the device may form or provide the sole node of the network or the intermediate network. In particular, in this case, the network does not comprise another device-external server as a node for performing functions of the network. In this case, for example, at least one instance of the above-described device-external server may be integrated in the apparatus or provided by it, for example as an extension of the gateway or the control and evaluation apparatus. However, this does not exclude a signal and/or data connection may be made from the network to a server apparatus.

In another embodiment, another node of the network is provided by another device for transferring data according to one of the embodiments described in the present disclosure.

Also described is a system having more than one network according to one of the previously described embodiments. A common node for all networks may be provided, for example, by the above-described device-external server. Alternatively or in addition, each of the networks, in particular each network designed as a femto network, may have a signal and/or data connection to a home network of a mobile service provider and/or to a backend apparatus.

The invention will be described in greater detail with reference to multiple embodiments. The figures show the following:

FIG. 1 is a schematic block diagram of a device according to the invention,

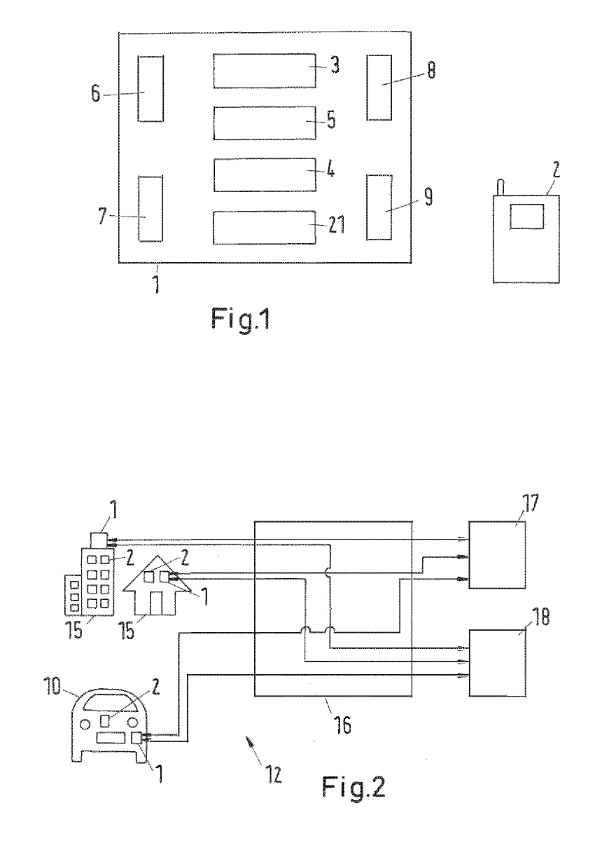

FIG. 2 is a schematic block diagram of a network according to the invention,

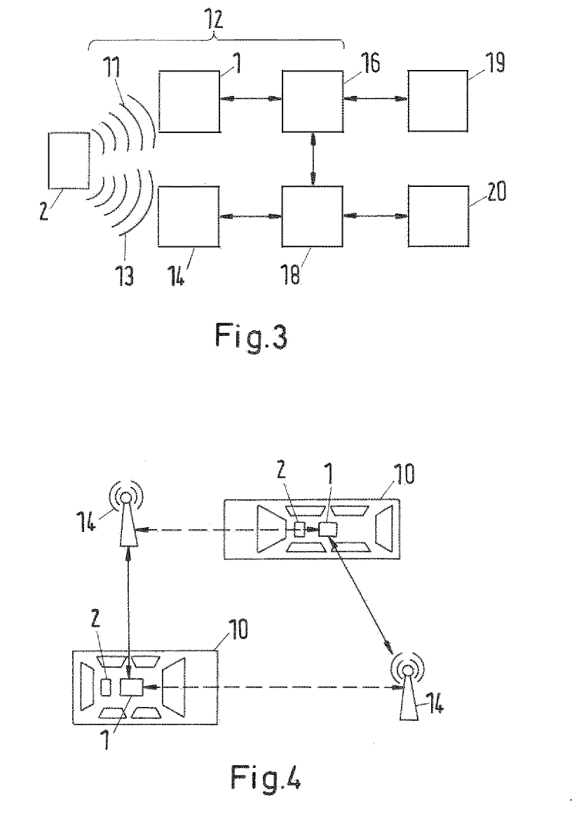

FIG. 3 is an additional schematic block diagram of a network according to the invention, and

FIG. 4 is a schematic plan view of vehicles with a device according to the invention.

Hereinafter, like reference numerals designate elements having like or similar technical features.

FIG. 1 shows a schematic block diagram of a device 1 according to the invention for transferring data from and to a terminal 2, for example a mobile telephone. The device 1 comprises an apparatus 21 for providing a WLAN wireless network 11 (see FIG. 3); this apparatus comprises one or more antenna elements for transmitting signals via the WLAN. Furthermore, the apparatus 21 may comprise a transmitting/receiving apparatus that controls data transfer over the WLAN wireless network 11.

Of course, the terminal 2 may also comprise a transmitting/receiving apparatus for WLAN signals.

The device 1 further comprises an apparatus 3 for transferring data to at least one external apparatus, for example a device-external server. The apparatus 3 may be designed, in particular, as a modem, and preferably as a wireless modem. The device 1 further comprises a control and evaluation apparatus 4, which is designed as an IMS controller or provides such a controller. The device 1 further comprises a gateway apparatus 5, which provides Trusted WLAN Access Gateway and Trusted WLAN AAA Proxy functions. As a result, a trusted access for a terminal 2 can be provided via the WLAN wireless network 11. This gateway apparatus 5 can be provided by the control and evaluation apparatus 4. However, provision of this apparatus 5 is not absolutely necessary.

A part of the device 1 shown in FIG. 1, but not absolutely necessary, is a position-determining apparatus 6, in particular a position-determining apparatus 6 designed as a GNSS sensor. By means of this position determining apparatus 6, a position of the device 1 in a reference coordinate system may be determined. The device 1 may further comprise a storage apparatus, not shown. In this storage apparatus, for example, coordinates of base stations 14 (see FIG. 4) or radio cells can be stored, and a data transfer between the device 1 and a base station can occur via the apparatus 3 for transferring data. Based on a position of the device 1 determined by means of the position determining apparatus 6, it is possible to determine e.g. the nearest base station 14. Also, the position of a future nearest base station 14 may be determined; this refers to a base station 14 which, as the vehicle 10 continues to travel in the direction of travel, is expected to have the best connection characteristics, e.g., the base station among a set of neighboring base stations 14 that has the shortest distance to that vehicle 10. Then, an antenna element of the vehicle 10 or the device 1 may be selected for establishing a connection to the base station 14 which enables data transfer at a desired data transfer rate and/or data transfer quality. The device 1 may further comprise a hands-free apparatus 7. This hands-free apparatus 7 in turn may comprise a microphone and at least one speaker.

Furthermore, the device 1 may comprise a communication interface 8 for transferring data to and from a device-external communication system, for example a vehicle communication system. By means of the communication interface 8, it is possible to transfer data to the device-external communication system and, for example, subscribers connected to that system. By way of example, a further hands-free apparatus or a display apparatus may have a signal and/or data connection to the external communication system, and by means of the communication interface 8, data can be transferred from the device 1 to the other hands-free apparatus and/or the display apparatus.

The device 1 further comprises an apparatus 9 for terminal detection. By means of the apparatus 9 for terminal detection, the device 1 and/or the terminal 2 may detect whether a terminal 2, in particular a Wi-Fi-calling-capable terminal 2, is located in the vicinity of the device 1 within a predetermined area. For example, the apparatus 9 may enable terminal detection via NFC (Near Field Communication) or Bluetooth™. The device 1 shown in FIG. 1 may in particular be arranged in a vehicle 10. In this case, the WLAN wireless network 11 may be provided in a vehicle interior.

By means of the device 1, a WLAN wireless network 11 can be provided, which may be part of a network 12 (see FIG. 2) for transferring data. The terminal 2 may change from a transmission/reception mode in which a data transfer to a base station 14 takes place via a wireless network 13 of a mobile service provider, for example an LTE wireless network, which may also be referred to as a radio cell, to a transmission/reception mode in which data transfer takes place via the WLAN wireless network 11.

The data transfer enables a Wi-Fi calling to be performed. In this case, the data transfer takes place in order to carry out telephony, in particular IP telephony.

In this case, the control and evaluation apparatus performs functions of an IMS, in particular a call session control function. This can mean that the control and evaluation apparatus 4 performs an authentication and authorization of the terminal 2 when it changes to the transmission/reception mode with data transfer via the WLAN wireless network 11. Furthermore, the control and evaluation apparatus 4 may control the setup and termination of a connection for transferring data between the terminal 2 and, for example, an additional terminal (not shown).

For example, the terminal 2 may be assigned a predetermined identifier, particularly a SIP URI. The terminal 2 and hands-free apparatus 7 can be operated under the predetermined identifier by means of the device 1. If e.g. audio data is transferred from an additional terminal to the terminal 2 in a connection between the terminal 2 and another terminal via the device 1, then this audio data may be transferred to and output from the hands-free apparatus 7 instead of the terminal 2.

If the hands-free apparatus 7 is not part of the device 1, but connected to the device 1 via the communication interface 8, the audio data may be transferred to the hands-free apparatus (not shown) via the communication interface 8 and output from the hands-free apparatus.

FIG. 2 shows a schematic block diagram of a network 12 for transferring data from and to at least one terminal 2. Shown is a vehicle 10, in which a device 1 according to the embodiment shown in FIG. 1 is arranged. Also shown are buildings 15, in each of which the corresponding device 1 is arranged.

Also shown are various terminals 2. Here the devices 1 for transferring data form nodes of a network 12, which may also be referred to as an intermediate network. For example, in addition to the devices 1, the intermediate network 12 may comprise a server 16, which also forms a node of the network 12. The intermediate network 12 may have a reduced EPC architecture. Here, the intermediate network 12 may comprise one or more of the following elements: PDN Gateway, vPCRF, 3gpp AAA Proxy, TRF, P-CSCF, IBCF, MGCF. For example, the following elements are not necessarily part of the intermediate network 12: Serving Gateway, S-CSCF, HSS. Thus, the devices 1 are part of the intermediate network 12.

Both the device 1 and the server 16 may each comprise elements of the intermediate network 12. In this case, the server 16 may in particular comprise elements that serve to perform functions in each of a plurality of intermediate networks 12. The device 1 may further comprise elements which serve to perform device-specific functions.

However, the intermediate network 12 may also be a femto network. In this case, all the functions of the intermediate network are performed by the device 1. Also, the device 1 may comprise all the elements of the intermediate network 12 described above. In this case, therefore, the device 1 provides an intermediate network 12.

The device 1 arranged in the vehicle 10 may perform a data transfer between the device 1 and the server 16, for example via an LTE connection, in particular by means of a wireless modem, which may form the apparatus 3 for transferring data as shown in FIG. 1. For this purpose, the network of a mobile service provider may be used, and the network of the mobile service provider may be used as a medium for transferring data.

From the server 16, this data may then be forwarded to a virtual network 17 or to a home network 18 of a mobile service provider.

The intermediate network 12 is in particular a roaming network. This roaming network may in particular provide and/or perform functions that are performed or provided at least partially or completely by a home network 18, which is provided by e.g. a mobile service provider. Such functions may in particular be telephony functions.

If the intermediate network 12 is a femto network, the data transfer to the server 16 is not absolutely necessary, because the server is not needed to perform the functions. However, in this case, data transfer between the device 1 and a backend 19, which will be described in more detail below (see FIG. 3), and/or the home network 18, may be performed for example via an LTE connection, in particular by means of a wireless modem, which may form the apparatus 3 for transferring data shown in FIG. 1.

Data transfer from the devices 1 arranged in the buildings 15 may likewise take place via an LTE connection or via a DSL connection to the server 16. In this case, the apparatus 3 may also be designed as a DSL modem. As described above, the server 16 may forward the data to a virtual network 17 or to the home network 18 of a mobile service provider. A virtual network 17 may refer to the network of a virtual network operator. These networks use the infrastructure of an existing mobile service provider, which may also be referred to as a mobile network operator.

In this intermediate network, various desired functions or applications may be carried out, in particular for performing Wi-Fi calling or the telephony described above.

FIG. 3 is a schematic block diagram of a network 12 according to the invention.

A terminal 2 is shown, which is connectable to a base station 14 via a wireless network 13. The base station 14 may serve to provide a physical connection to a home network 18 of a mobile service provider. This home network may have an EPC architecture. Further, the home network 18 may form an IMS or provide the functionalities thereof. This IMS may have a signal and/or data connection to a backend, represented symbolically by a block 20. A backend 20 of this kind will be described in more detail below. It is also conceivable that the home network 18 may have an interface for a data signal transmitted over a Wi-Fi network.

Furthermore, the terminal 2 may be connected to the home network 18 via the WLAN wireless network 11 provided by a device 1, and via an intermediate network 12. The functionalities for carrying out Wi-Fi calling may in this case be provided either in or by means of the intermediate network 12. In this case, the terminal 2 may change from a send/receive operation in which data is transferred via the wireless network 13 to the base station 14, to a send/receive operation in which data is transferred to the device 1 via the WLAN wireless network 11. This may take place, in particular, when a Wi-Fi-calling-capable terminal 2 in spatial proximity to the device 1 is detected by means of the apparatus 9 for terminal detection shown in FIG. 1.

The intermediate network 12 also forms an IMS or a reduced IMS or provides the functionalities thereof. This IMS or reduced IMS may have a signal and/or data connection to a backend, represented symbolically by a block 19. A backend in this case may comprise one or more server apparatuses.

Additional central services or server functions may be provided by means of the backend 19. The backend 19 may e.g. serve for collecting, evaluating and processing of data including storage of the results, the data being transferred from the intermediate network 12. Among other things, the services provided may access these results and provide overall coordination of actions within an intermediate network 12 or within a plurality of intermediate networks 12, for example in femto networks.

The intermediate network 12 may in particular be a roaming network.

For a user of the terminal 2 it advantageously results that the same phone number and the same functionality is provided as in a data transfer via the wireless network 13 to the base station 14. It also advantageously results that other apparatuses in an environment that are different from the terminal 2, such as the previously described hands-free apparatus 7 or a display apparatus, can be integrated into the data transfer.

The provided Wi-Fi calling functionality may use existing standards such as VoWiFi standards. Furthermore, the proposed device 1 also enables operation for terminals 2 of different users. The device 1 may also allow operation with different mobile providers.

FIG. 4 is a schematic plan view of vehicles 10 with a device 1 according to the invention. As previously described, these allow the connection of terminals 2. Also shown are base stations 14. The devices 1 can in this case be integrated into an existing Telematics Control Unit of the vehicles 10. The devices 1, in particular the apparatus 3 for transferring data of the device 1 (see FIG. 1), can also be connected to an antenna unit (not shown) of the vehicles 10. By means of the position determining apparatus 6 shown in FIG. 1, a current position of the device 1 can be determined. Furthermore, based on the position of the device 1, each vehicle 10 can determine the position of the currently nearest base station 14 and, as previously described, the position of a future nearest base station 14. One or more antenna elements of the vehicle 10 are then selected and set to connect to the base station 14 in such a way that sensitivity in the direction of the currently nearest base station 14 is maximized. In this case, it is possible to switch from a connection to the currently nearest base station 14 to a connection to the future nearest base station 14 if the corresponding distances are the same and/or a desired data transfer rate and/or data transfer quality of a connection to the future nearest base station is ensured. After the change, one or more antenna elements of the vehicle 10 are then selected and set to connect to the base station 14, such that sensitivity in the direction of the future nearest base station 14 is maximized.

In FIG. 4, a solid arrow indicates a connection to the respective currently nearest base station 14, and a dashed arrow indicates a connection to the respective future nearest base station 14.

### LIST OF REFERENCE NUMERALS

1 Device
2 Apparatus for providing a WLAN wireless network
3 Apparatus for transferring data
4 Control and evaluation apparatus
5 Gateway
6 Position determining apparatus
7 Hands-free apparatus
8 Communication interface
9 Apparatus for terminal detection
10 Vehicle
11 WLAN wireless network
12 Network (intermediate or roaming network)
13 Wireless network
14 Base station(s)
15 Building
16 Server
17 Public network
18 Home network
19 Backend of network
20 Backend of home network
21 Apparatus for providing a WLAN wireless network

1-18. (canceled)

19. A device for transferring data from and to at least one terminal, the device comprising:
at least one apparatus for providing a terminal wireless network;
at least one apparatus for transferring data to at least one external apparatus;
at least one control and evaluation apparatus being an IMS controller or providing an IMS controller; and
the device being a part of an intermediate network or providing the intermediate network, the intermediate network forming a roaming network.

20. The device according to claim 19, wherein said IMS controller is configured to provide a call session control function.

21. The device according to claim 19, wherein the terminal is associated with a predetermined identifier, and wherein the device is configured to operate different terminals under the predetermined identifier.

22. The device according to claim 19, wherein said apparatus for transferring data to an external apparatus is a device for wireless data transfer.

23. The device according to claim 19, further comprising a position-determining apparatus.

24. The device according to claim 19, being a hands-free apparatus or providing a hands-free apparatus.

25. The device according to claim 19, further comprising a data transfer interface for wired data transfer to and from an external system.

26. The device according to claim 19, further comprising an apparatus for terminal detection.

27. The device according to claim 19, wherein the device is disposed in a vehicle.

28. A method for transferring data from and to at least one terminal, the method comprising:
providing a device according to claim 19 and causing the control and evaluation apparatus to perform at least one function of an IMS controller.

29. The method according to claim 28, which comprises transferring audio data to a hands-free apparatus.

30. The method according to claim 28 which comprises switching the terminal between a data transfer via a wireless network different from the terminal wireless network to data transfer via the terminal wireless network, or vice versa.

31. The method according to claim 28, which comprises transferring data from and to at least one external apparatus via an antenna element, and adjusting the antenna element, or selecting the antenna element, to provide for a predetermined sensitivity in a direction of a selected base station.

32. The method according to claim 28, which comprises using a wireless network for transferring data between the device and an external apparatus and switching to a different wireless network.

33. The method according to claim 28, which comprises effecting a temporaneously parallel data transfer from and to a plurality of terminals.

34. A network for transferring data from and to at least one terminal, the network comprising a plurality of network nodes, and wherein at least one of said network nodes is a device according to claim 19.

35. The network according to claim 34, wherein said network nodes include a server external to said device.

36. The network according to claim 34, wherein said network nodes include a plurality of said devices each forming a node of the network.
